(19) United States
(12) Patent Application Publication
(10) Pub. No.: US 2015/0139752 A1
(43) Pub. Date: May 21, 2015

(54) Backing Bar for Mounting Objects on Thin Walls and Methods of Use

(71) Applicant: Carlos A. Torres, Montgomery, TX (US)

(72) Inventor: Carlos A. Torres, Montgomery, TX (US)

(21) Appl. No.: 14/338,400

(22) Filed: Jul. 23, 2014

Related U.S. Application Data
(60) Provisional application No. 61/858,707, filed on Jul. 26, 2013.

(51) Int. Cl. B23P 19/06; F16B 37/00

(52) U.S. Cl. CPC B23P 19/06; F16B 37/00
USPC 411/427; 29/467

(57) ABSTRACT

Methods and apparatuses are described for providing a threaded backing plate for mounting objects on a thin wall and/or on walls where it is difficult or impossible to access the back of the wall for placing and backing up a nut or for using other mounting and retention means.

### CROSS REFERENCE TO RELATED APPLICATION

This application claims priority to U.S. Application No. 61/858,707 filed on Jul. 26, 2013, the disclosure of which is incorporated herein by reference for all purposes.

### FIELD OF THE INVENTION

The present invention relates to mounting objects on walls. In particular, the present invention relates to mounting objects on thin walls or in locations where it is difficult or impossible to access the back of the wall.

### BACKGROUND OF THE INVENTION

One recently disclosed technique (not acknowledged as being prior art) for attaching objects to a thin wall uses a tool made up of an externally threaded tube that has a narrow nose at one end and is used with a pull string to permit a backing plate to be placed in position behind the wall. The backing plate has threaded holes for receiving conventional mounting bolts. In this technique, the string is fed through mounting holes in the wall to a remote location that has access to the backside of the wall. The tube tools are threaded into baseplate mounting holes and the free ends of the string are inserted through the narrow nose to the far end of the tube where a knot is tied at the end of each string so that it cannot be pulled back through the tube.

The strings are pulled back out through the wall mounting holes to pull the tubes and attached backing plate to the wall mounting holes where the narrow end of the tubes can pass through the mounting holes and become accessible outside of the wall. The free string ends are fed through nuts which are then advanced over the narrow end of the tube tools to engage with the tube threads where they are tightened against the mounting wall to temporarily hold the backing plate in position. The tubes are replaced, one at a time, with a standard bolt which is used to permanently hold the mount in place. The backing plate is held in position by either a tube tool or a bolt during this replacement process.

Much of the prior art uses expanding attachment devices to mount objects in areas where the backside of the mounting surface is unavailable for nuts or other common securing means. These devices generally require that the attachment mechanism have an initial configuration that is small enough to be inserted completely through the mounting hole with the capacity to subsequently expand dimensionally to a configuration that will prevent retraction of the device through the mounting hole.

### SUMMARY OF THE INVENTION

The present invention permits the placement and attachment of a backing plate without the need for specially configured tools.

The present invention permits the placement and attachment of a backing plate using only a small diameter limber, string or line.

The present invention permits the placement and attachment of a backing plate behind a wall that is completely inaccessible except through the mounting holes.

The present invention permits the placement of a backing plate behind a mounting wall by inserting the plate through a mounting bolt hole in the wall.

The present invention employs a small diameter opening adjacent the threaded bolt hole of a backing bar to receive a small diameter string that can be used to align the bolt hole with a wall mounting hole. When properly aligned, a bolt may be inserted through a mount hole from the accessible side of the wall and threaded into the bolt hole to provide a retention mechanism for the bolt and any object being secured to the wall by the bolt.

The present invention employs a bendable wire to feed a string from an external access area through the mounting hole, and into the internal inaccessible area and then back to an area where it may be accessed from the external access area.

In one form of the invention, the external access area is the area immediately outside the wall surface at the location the object is to be mounted. The internal inaccessible area is an area immediately adjacent and behind the wall where the object is to be mounted. A mounting hole extending between the front and back wall surfaces provides the opening for inserting the backing bar from the external area into the inaccessible area.

These and further features and advantages of the present invention will become apparent from the following detailed description, wherein reference is made to the figures in the accompanying drawings.

### BRIEF DESCRIPTION OF THE DRAWINGS

FIG. 1 illustrates one embodiment of bar back of the present invention in preparation for being inserted into an inaccessible area within a kayak.

FIG. 2 is a cross-sectional view of a portion of a wall on which the bar back of the present invention is affixed.

FIG. 3 is a cross-sectional view of a portion of a kayak wall showing a string orienting the bar back of the present invention with the openings in the wall.

FIGS. 4, 5, and 6 are views similar to FIG. 3, but showing the bolts to be threaded through the bar back.

FIGS. 7 and 8 are views similar to FIGS. 4, 5, and 6, but showing a partially threaded bolt and a string running through only a single opening of the bar back of the present invention.

FIG. 9 is an elevational view of another embodiment of the bar back of the present invention.

FIG. 10 is a partial view of another embodiment of the bar back of the present invention.

FIG. 11 is an elevational view of another embodiment of the bar back of the present invention.

FIG. 12 shows the string being passed through inaccessible portion of the kayak using gravity.

FIG. 13 shows another method of passing the string through the bar back of the present invention.

FIGS. 14 and 15 are partial views showing the string passed through the alignment holes of the bar back of the present invention twice.

FIG. 16 is shows one embodiment of the bar back of the present invention inserted through the mounting holes of a wall.

FIG. 17 shows a wire threaded through the mounting holes of a wall and attached to the string.

### DETAILED DESCRIPTION OF PREFERRED EMBODIMENTS

While the following figures and examples describe the invention with particular reference to a kayak, it will be understood that the present invention can be used with any dividing structure, partition, wall, or the like.

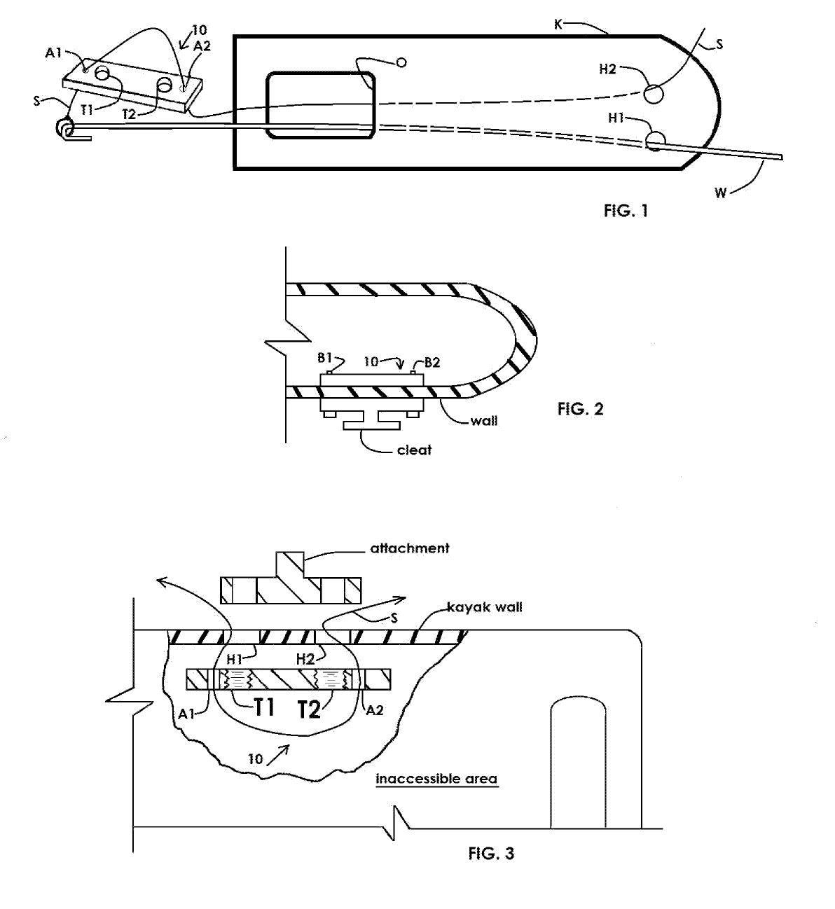

FIG. 1 illustrates an elongate bar back 10 of the present invention in preparation for being inserted into an inaccessible area within a kayak K. A hooked wire W inserted through a mounting hole H1 extends through an inaccessible area within the kayak K and exits through a kayak access opening O. The hook HK at the end of the wire W attaches to a first end of an alignment string S, which feeds through alignment holes A1 and A2 in the bar back 10 and extends back through the inaccessible area within kayak K and exits through a mounting hole H2.

The holes A1 and A2 of bar back 10 are located between the closest end of bar back 10 and the respective internally threaded openings, also referred to as bolt holes, T1 and T2. The bar back 10 is used to receive threaded bolts B1 and B2 which each extend through the kayak wall to secure an object, such as a cleat illustrated in FIG. 2, to the external surface of kayak K. When rotated, the threads of bolts B1 and B2 engage and mate with their associated bolt holes T1 and T2. Applying tension to string S brings bolt holes T1 and T2 into register with mounting holes H1 and H2 and prevents the bar back from rotating as the bolts B1 and B2 are initially rotated into the bolt holes T1 and T2. The engagement of two bolts prevents the bar back from rotating as the bolts are finally tightened.

In the mounting procedure illustrated in FIG. 1, the string S is brought into position extending from the hole H2 with the use of the hooked wire W. The hooked wire W is first extended through the hole H2 and through the inaccessible area of kayak to the access opening O where it is secured to one end of the string S. The hooked wire W is then retrieved back through hole H2 pulling string S out through hole H2 as well.

Once the end of the string S has been returned through hole H2, the hooked wire W is passed through hole H1 and extended through the inaccessible area of the kayak to the access opening O where it is attached to the opposite end of the string S that has first been threaded through the access openings A1 and A2 of the backing bar 10. The string S is fed through the bar 10 in a direction such that when the bar 10 is pulled into position against the back surface of the mounting wall, the string ends extend directly from the alignment holes A1 and A2 through the wall mounting holes H1 and H2 as illustrated in the various Figures.

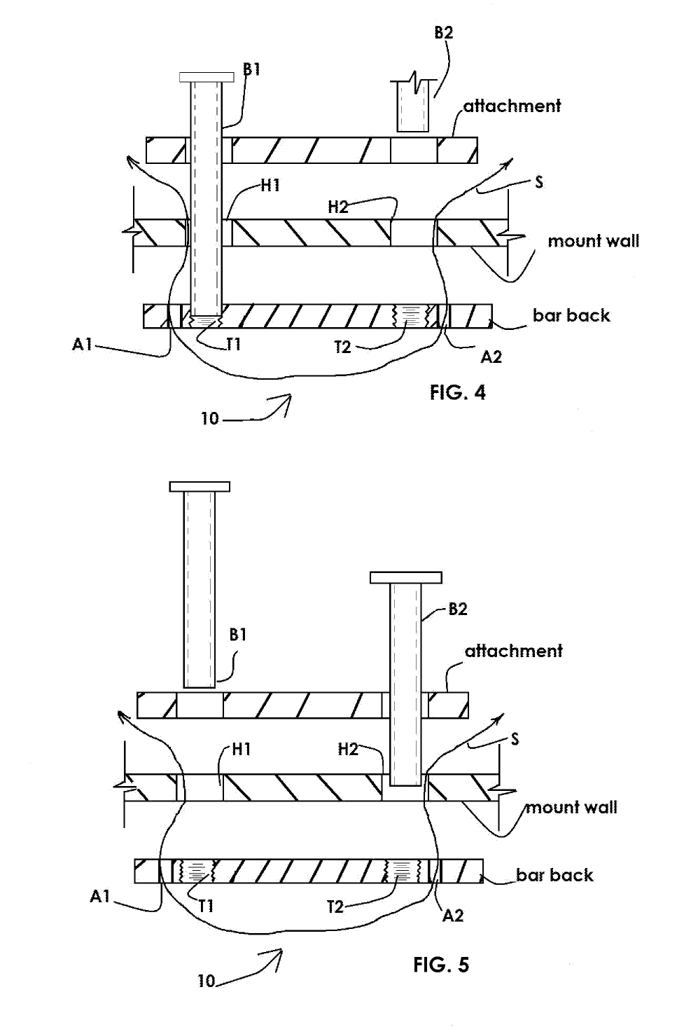

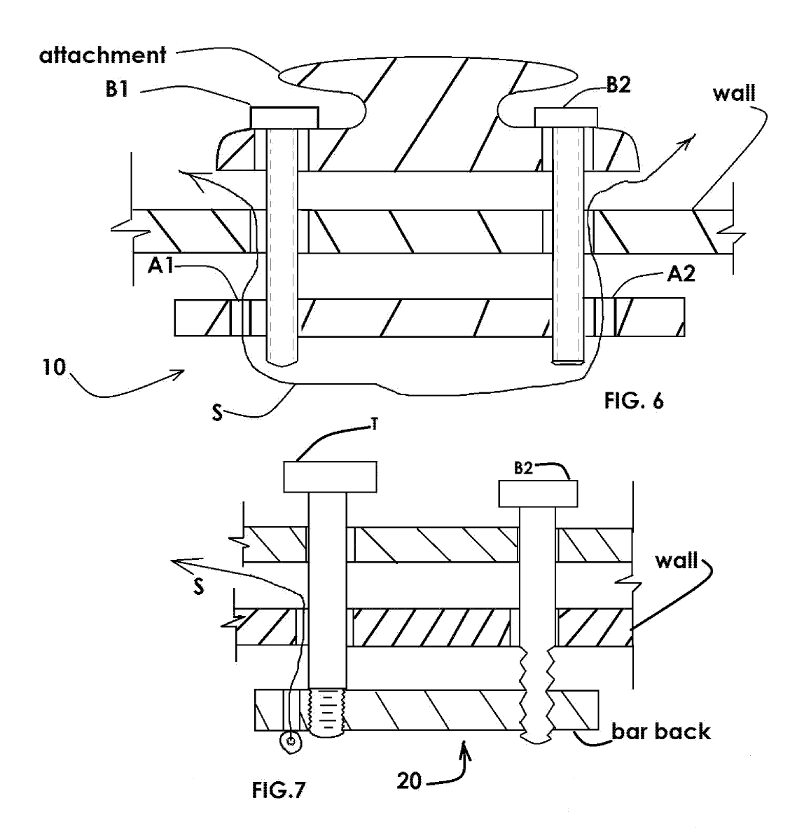

FIG. 3 illustrates the string S being used to orient the bar back 10 in the inaccessible area behind the kayak K wall. The bar back 10 is centered by applying constant tension to both ends of the string S so that the bar back 10 is brought closely against the inside surface of the mounting wall with the center of the bolt holes T1 and T2 being closely aligned with the center of the wall mounting holes H1 and H2. This alignment process is accomplished in part as a result of the position of the alignment holes A1 and A2 between the bolt holes T1 and T2 and the respective outer ends of the bar back 10. This design is important to ensure that tensioning the string in a direction parallel to the long axis of the bar back 10 centers the bolt holes T1 and T2 with the wall mount holes H1 and H2. This alignment is also illustrated in FIGS. 4, 5 and 6.

When adequate tension is applied to the string S, the bar back 10 is held in close proximity to the inside wall surface so that the center of the mounting bolts B1 and B2 will be in close alignment with the center of the respective bolt holes T1 and T2. The continued application of tension to the string S as a bolt is being advanced toward and against the bolt hole of the bar back causes the bar back to center on the bolt threads so that rotation of the bolt will engage the threads. This self-centering action is assisted by the nearness of the alignment holes A1 and A2 to the center of the bar back bolt holes T1 and T2 and by the application of diametrically opposed tensioning forces being exerted through the string S.

A strong, small diameter monofilament line is preferred for the string S, however, any small diameter, elongate, flexible body may be employed. Similarly, while wire is a preferred material for drawing string through the mounting holes, other materials and methods may be suitable.

The mounting holes H1 and H2 are preferably as small as possible, leaving only enough room to accommodate the string S and the bolts B1 and B2. When a mounting hole is used to insert the bar back into the inaccessible area, as hereinafter described, the mounting hole so used need only be large enough to just receive the bar back.

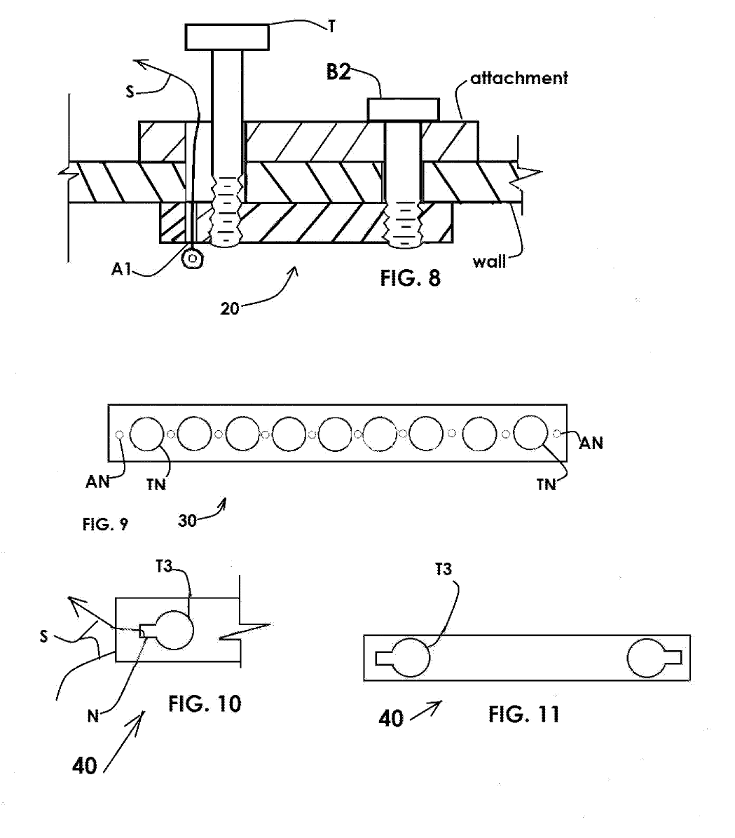

FIGS. 7 and 8 illustrate another embodiment of the invention, in which only a single string attachment and a partially threaded bolt P are used to position the bar back 20 of the present invention. In the form of the invention illustrated in FIG. 7, the bar back 20 is brought into position by pulling the string S until the bar back 20 engages the under surface of the mounting wall. It may assist thread engagement to position the kayak such that an imaginary line connecting the centers of the two mounting holes H1 and H2 would be generally vertical. For example, lifting one end of the kayak K could achieve the necessary position. This positioning uses gravity to align the bolt holes T1 and T2 with the mounting holes H1 and H2. Specifically, the bar back will hang vertically from the string at the uppermost positioned mounting hole and align the bottom bar back hole with the lowermost positioned mounting hole. Tension on the string S aligns the threaded bolt openings T1 and T2 in the bar back 20 with the mounting holes H1 and H2 so that the partially threaded bolt P may be made up into the bolt opening. A bolt B2 may be inserted in the second mounting hole to provide a backstop to prevent rotation of the bar back 20 during the time that the partially threaded bolt P is being tightened into the bar back 20. When the partially threaded bolt P is made up to the end of its threads, it is tightened firmly to resist rotating in the bolt hole T1 during the remainder of the attachment procedure. Once the partially threaded bolt P is tightly engaged with the bar back 20, the partially threaded bolt P and attached bar back 20 can be maneuvered to align the second bolt hole T2 of the bar back 20 with the second mounting bolt B2. When the second bolt B2 is tightly engaged with the bar back 20, the partially threaded bolt P may be removed and replaced with a permanent mounting bolt B1. During this latter step, the second bolt B2 is tightened down firmly to maintain the alignment of the bar back mounting hole previously occupied by the partially threaded bolt P.

FIG. 9 illustrates a form of the invention in which multiple bolt holes and alignment holes are provided on a single bar back 30. The arrangement illustrated in FIG. 9 allows the bar back 30 to be employed to mount objects having mounting holes spaced at varying distances. As shown in FIG. 9, alignment holes AN are positioned proximal bolt holes TN.

FIGS. 10 and 11 of the invention illustrate a bar back 40 in which the string S may be accommodated in a notch N that extends into and communicates with the internal space surrounded by the threaded area of a bolt hole T3. The notch N provides a function similar to that provided by the alignment bores A1 and A2 where the string is not interfering with the engagement between the threads.

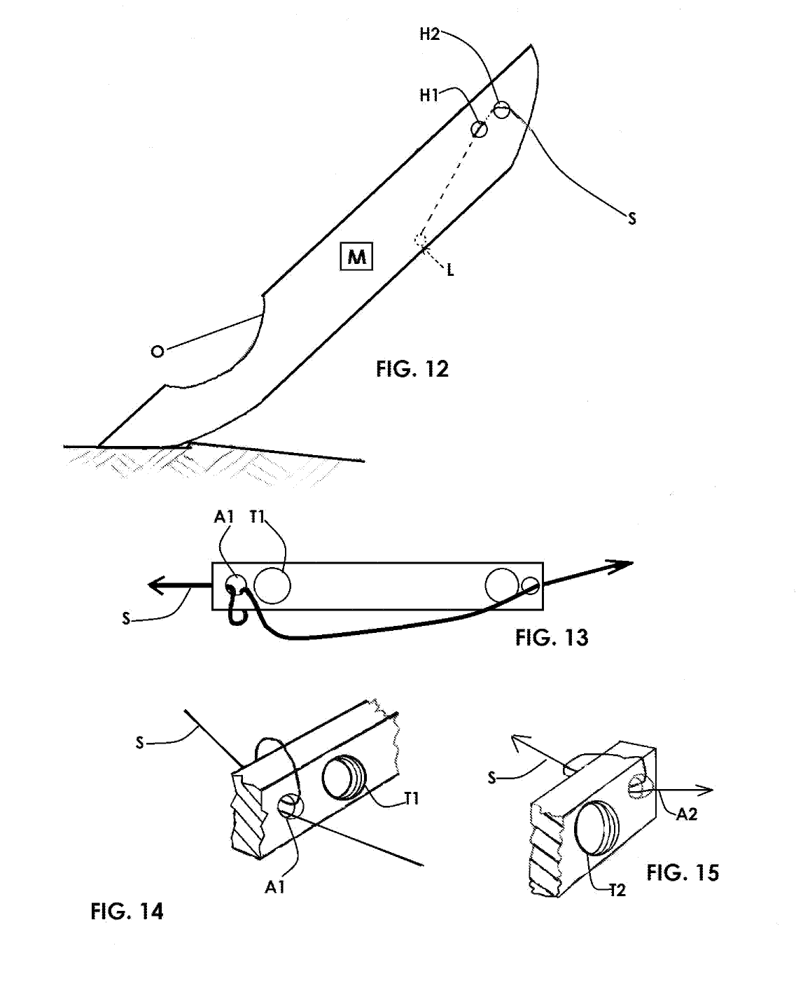

FIG. 12 illustrates another method for extending the alignment string S between a mounting hole H2 and an access opening O. A small weight L is attached to the end of the string S and inserted into the inaccessible area through the mounting hole H2. The weight is allowed to fall by gravity, where it may be accessed through the opening O. The remainder of the installation procedure is as previously described with respect to FIG. 1.

The weight L may be made of ferrous material whereby a magnet M may be moved along the outside wall to move the metal weight and advance the attached string through the kayak without the use of gravity.

FIGS. 13, 14 and 15, illustrate the string S being passed through the alignment hole twice to prevent the bar back from sliding along the string during the placement process. This may be done at one or more of the alignment holes as desired.

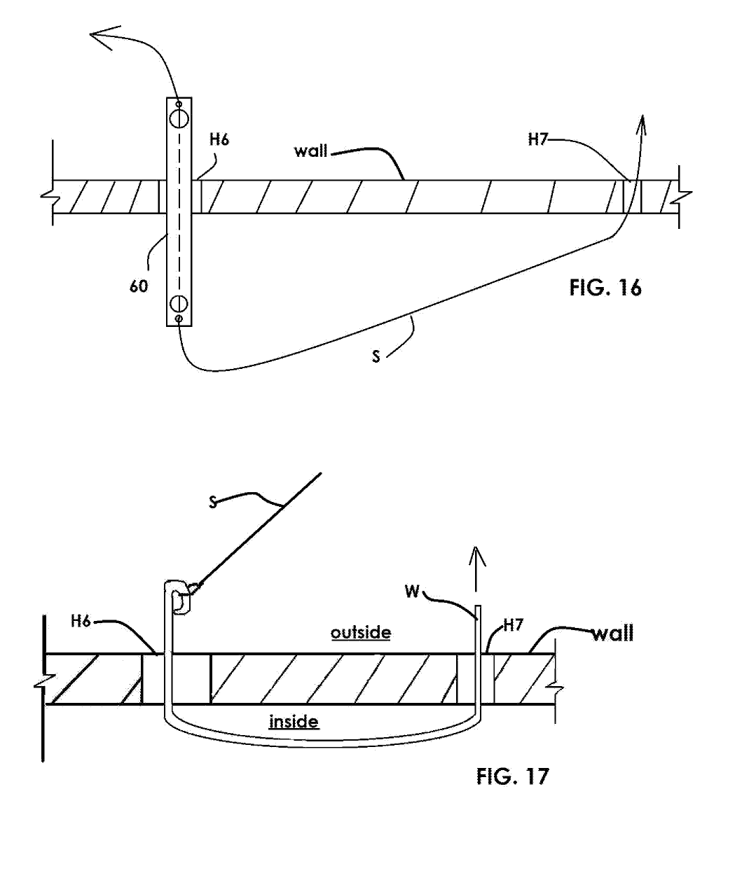

FIG. 16 illustrates a form of the invention in which the bar back 60 is inserted into a mounting hole H6 that has a diameter very slightly larger than the width of the bar back. Once the bar, 60, has been inserted into the inaccessible area, the installation process proceeds in the manner described with reference to FIGS. 2 through 6.

FIG. 17 illustrates an alternative method for placing the string S through the mounting holes H6 and H7. The wire W is curved so that after being inserted through the hole H6, it can be directed to return and exit through the mounting hole H7. The mounting plate can then be secured to the string as illustrated in FIGS. 1 through 6 and inserted into the mounting hole 86 as illustrated in FIG. 16.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A method for securing an object to an external surface of a dividing structure having an internal and external surface, comprising:
providing at least one structure opening through the dividing structure, said structure opening extending from the external surface to the internal surface;
extending an attachment portion of an elongated attachment tool through said structure opening in a direction extending from the external surface to the internal surface of said dividing structure;
providing a backing member having at least one internally tapped hole for receiving one end of a threaded bolt and having at least one alignment opening proximal said at least one internally tapped hole;
engaging a flexible securing line with said alignment opening of said backing member;
securing said attachment portion of said elongated attachment tool to said flexible securing line;
retracting said attachment tool and said flexible securing line from said structure opening in a direction from said internal surface toward said external surface;
exerting a force on said securing line to bring said internally tapped hole on said backing member into registry with said structure opening;
extending a fastener through said structure opening and securing said fastener in said internally tapped hole, said flexible line engaged with said backing structure at a point removed from said attachment configuration whereby said registry may be achieved without interfering with the securing of said fastener to said internally tapped hole.

2. A method for securing an object to an external surface of a dividing structure having an internal and external surface, comprising:
providing at least one structure opening through the dividing structure, said structure opening extending from the external surface to the internal surface;
extending a weighted end of a flexible securing line through said structure opening in a direction extending from the external surface to the internal surface of said dividing structure;
providing a backing member having at least one internally tapped hole for receiving one end of a threaded bolt and having at least one alignment opening proximal said at least one internally tapped hole;
engaging said flexible securing line with said alignment opening of said backing member;
retracting said flexible securing line from said structure opening in a direction from said internal surface toward said external surface;
exerting a force on said securing line to bring said internally tapped hole on said backing member into registry with said structure opening;
extending a fastener through said structure opening and securing said fastener in said internally tapped hole, said flexible line engaged with said backing structure at a point removed from said attachment configuration whereby said registry may be achieved without interfering with the securing of said fastener to said internally tapped hole.

3. The method of claim 3 further comprising:
using a magnet to guide said weighted end of said flexible securing line.

4. A method for securing an object to an external surface of a dividing structure having an internal and external surface, comprising:
providing at least one structure opening through the dividing structure, said structure opening extending from the external surface to the internal surface;
providing a backing member having at least one internally tapped hole for receiving one end of a threaded bolt and having at least one alignment opening proximal said at least one internally tapped hole;
engaging a flexible securing line with said alignment opening of said backing member;
extending said backing member through said structure opening in a direction extending from the external surface to the internal surface of said dividing structure;
exerting a force on said securing line to bring said internally tapped hole on said backing member into registry with said structure opening;
extending a fastener through said structure opening and securing said fastener in said internally tapped hole, said flexible line engaged with said backing structure at a point removed from said attachment configuration whereby said registry may be achieved without interfering with the securing of said fastener to said internally tapped hole.

5. A backing member for use in on a partition having a front and rear surface wherein the backing member is to be used as a rear surface securing base for receiving a threaded bolt to secure an object to the front surface of said partition, comprising:
a backing member having one or more internally tapped holes for receiving one end of a threaded bolt,
said member having at least one alignment opening adjacent at least one of said internally tapped holes for receiving a flexible line, and
said alignment opening positioned relative to said one or more internally tapped holes whereby force exerted through said line can bring said internally tapped hole into engagement with an opening through said partition whereby a bolt extending through said opening can be threadably engaged with said tapped hole without interference from said line.
